(19) United States
(12) Patent Application Publication
(10) Pub. No.: US 2009/0324790 A1
(43) Pub. Date: Dec. 31, 2009

(54) METHODS AND SYSTEMS FOR RECONDITIONING FOOD PROCESSING FLUIDS

(75) Inventors: John D. Hilgren, Shoreview, MN (US); Stefanie E. Gilbreth, Apple Valley, MN (US)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 12/492,556

(22) Filed: Jun. 26, 2009

Related U.S. Application Data
(60) Provisional application No. 61/076,319, filed on Jun. 27, 2008.

(51) Int. Cl. A23L 3/3463; C02F 9/04; C02F 1/24; C02F 1/68; C02F 1/52

(52) U.S. Cl. 426/335; 210/764; 210/703; 210/712; 210/194; 210/150

(57) ABSTRACT

The present invention is directed to methods and systems for reconditioning a used food processing fluid. The reconditioned fluids can be used in an upstream or downstream food processing application.

### CROSS REFERENCE TO RELATED APPLICATIONS

This application claims priority to U.S. Provisional Application Ser. No. 61/076,319, filed on Jun. 27, 2008 and entitled “METHOD FOR RECONDITIONING FOOD PROCESSING FLUIDS.” The entire contents of this patent application are hereby expressly incorporated herein by reference including, without limitation, the specification, claims, and abstract, as well as any figures, tables, or drawings thereof.

### FIELD OF THE INVENTION

The present disclosure is related to methods and systems for reconditioning food processing fluids.

### BACKGROUND

Modem food processing operations require a large quantity of water in processing foods. As an example, poultry slaughter operations use about six to eight gallons of water per bird. During poultry slaughter, water is used to clean and to chill carcasses, parts, and organs. After the water is used to process the food product, the effluent water is typically sent directly to a drain and disposed of through either on-site or off-site wastewater treatment. It is desirable to minimize the amount of water used during food processing operations in order to reduce water costs, energy, and labor, without compromising the safety or efficiency of the process.

The reconditioning of food processing fluids for reuse in additional food processing applications has been adopted for some processes. However, the methods used to recondition fluids for reuse are not applicable to a broad array of food products or food processing applications. Thus, there is a need for improved methods for reconditioning food processing fluids to reduce cost and conserve resources.

### SUMMARY

The present invention provides methods for reconditioning a used food processing fluid for re-use in a food processing application. The methods comprise recovering the used fluid after it has been used in a food processing application, substantially removing a solid material from the recovered used fluid, and creating a combined reuse fluid with a desired level of antimicrobial agent. The combined reuse fluid is created by exchanging a portion of the recovered volume of the used fluid with an unused fluid and an effective amount of an antimicrobial agent. The effective amount of antimicrobial agent is based on a plurality of food processing parameters including, but not limited to, a targeted level of microorganism inactivation, a targeted time for fluid reconditioning, the temperature of the used food processing fluid, decay of the antimicrobial agent in the combined reuse fluid, and combinations thereof. The present invention also provides systems and apparatus for carrying out the methods of the present invention.

### BRIEF DESCRIPTION OF THE DRAWINGS

FIG. 1 is a block diagram of an embodiment of a reconditioning system of the present invention.

FIGS. 2a-2d are block diagrams of embodiments of a reconditioning system of the present invention.

FIG. 3 is a block diagram of an embodiment of a reconditioning system of the present invention.

FIGS. 4 and 5 graphically depict the impact of the pH of the food processing fluid containing peroxyacetic acid (POAA) solution on the reduction of the viable Salmonella count over time.

FIGS. 6-9 graphically depict the impact of the concentration of the POAA in a food processing fluid on the reduction of the viable Salmonella count over time.

FIG. 10 graphically depicts the impact of the temperature of the food processing fluid containing POAA on the reduction of the viable Salmonella count over time.

FIG. 11 graphically depicts the impact of organic residue in the food processing fluid containing POAA on the reduction of the viable Salmonella count over time.

### DETAILED DESCRIPTION

In some aspects, the present disclosure relates to methods, systems and apparatus for reconditioning a used food processing fluid for re-use in a food processing application. In some embodiments, the method includes recovering the used fluid after an application for food processing, removing a solid material from the recovered used fluid, and creating a combined reuse fluid with a desired level of antimicrobial agent. The combined reuse fluid can be created by exchanging up to about 50% of the recovered volume of used fluid with an unused fluid and an effective amount of antimicrobial agent. The effective amount of antimicrobial agent can be determined based on a plurality of food processing parameters.

So that the invention may be more readily understood certain terms are first defined.

As used herein, “weight percent,” “wt-%,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt-%,” etc.

As used herein, the term “about” refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

As used herein, the term “microorganism” refers to any noncellular or unicellular (including colonial) organism. Microorganisms include all prokaryotes. Microorganisms include bacteria (including cyanobacteria), lichens, fungi, protozoa, virinos, viroids, viruses, phages, and some algae. As used herein, the term “microbe” is synonymous with microorganism.

As used herein, the phrase “food product” includes any food substance that might require treatment with an antimicrobial agent or composition and that is edible with or without further preparation. Food products include meat (e.g. red meat and pork), seafood, poultry, fruits and vegetables, eggs, living eggs, egg products, ready to eat food, cheese, grains, wheat, seeds, roots, tubers, leaves, stems, corms, flowers, sprouts, seasonings, or a combination thereof. The term “produce” refers to food products such as fruits and vegetables and plants or plant-derived materials that are typically sold uncooked and, often, unpackaged, and that can sometimes be eaten raw.

As used herein, the phrase “plant” or “plant product” includes any plant substance or plant-derived substance. Plant products include, but are not limited to, seeds, nuts, nut meats, cut flowers, plants or crops grown or stored in a greenhouse, house plants, and the like. Plant products include many animal feeds.

As used herein, the phrase “meat” or “meat product” refers to all forms of animal flesh, including the carcass, muscle, fat, organs, skin, bones and body fluids and like components that form the animal. Animal flesh includes, but is not limited to, the flesh of mammals, birds, fishes, reptiles, amphibians, snails, clams, crustaceans, other edible species such as lobster, crab, etc., or other forms of seafood. The forms of animal flesh include, for example, the whole or part of animal flesh, alone or in combination with other ingredients. Typical forms of meat or meat products include, for example, processed meats such as cured meats, tenderized meats, marinated meats, flavor-injected meats, cooked meats, sectioned and formed products, minced products, finely chopped products, ground meat and products including ground meat, whole products, and the like.

As used herein the term “poultry” refers to all forms of any bird kept, harvested, or domesticated for meat or eggs, and including chicken, turkey, ostrich, game hen, squab, guinea fowl, pheasant, quail, duck, goose, emu, or the like and the eggs of these birds. Poultry includes whole, sectioned, processed, cooked or raw poultry, and encompasses all forms of poultry flesh, by-products, and side products. The flesh of poultry includes muscle, fat, organs, skin, bones and body fluids and like components that form the animal. Forms of animal flesh include, for example, the whole or part of animal flesh, alone or in combination with other ingredients. Typical forms of poultry include, for example, processed poultry meat, such as cured poultry meat, marinated poultry meat, flavor injected meats, cooked meats, sectioned and formed products, minced products, finely chopped products and whole products.

As used herein, the phrase “poultry debris” refers to any debris, residue, material, dirt, feces, digestive tract contents, offal, poultry part, poultry waste, poultry viscera, poultry organ, fragments or combinations of such materials, and the like removed from a poultry carcass or portion during processing and that enters a waste stream.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

As used herein, the phrase “air streams” includes food anti-spoilage air circulation systems. Air streams also include air streams typically encountered in hospital, surgical, infirmity, birthing, mortuary, and clinical diagnosis rooms.

As used herein, the term “food processing fluid” refers to any fluid suitable for use in a food processing application or a food transport application. Food process or transport fluids include, for example, produce transport waters (e.g., as found in flumes, pipe transports, cutters, slicers, blanchers, retort systems, washers, and the like), belt sprays for food transport lines, boot and hand-wash dip-pans, third-sink rinse waters, and the like. Food process fluids also include those used in food processing applications including, but not limited to, washing, rinsing, preserving, sanitizing, disinfecting, sterilizing, harvesting, peeling, cutting, blanching, scalding, cooking, chilling, irrigating, flavoring, pickling, soaking, marinating, curing, coating, transporting, floating, separating, sorting, disposing and combinations thereof. Food process fluids also include fluids such as brining solutions, water, and combinations thereof.

In some embodiments, a food processing fluid includes, but is not limited to, a food packaging rinse water. As used herein, a “food packaging rinse water,” refers to water used to rinse food packaging and containers after they have been sterilized using antimicrobial agents, e.g., peracetic acid, hydrogen peroxide.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “disinfectant” refers to an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). As used herein, the term “high level disinfection” or “high level disinfectant” refers to a compound or composition that kills substantially all organisms, except high levels of bacterial spores, and is effected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

As used in this invention, the term “sporicide” refers to a physical or chemical agent or process having the ability to cause greater than a 90% reduction (1-log order reduction) in the population of spores of Bacillus cereus or Bacillus subtilis within 10 seconds at 60° C. In certain embodiments, the sporicidal compositions of the invention provide greater than a 99% reduction (2-log order reduction), greater than a 99.99% reduction (4-log order reduction), or greater than a 99.999% reduction (5-log order reduction) in such population within 10 seconds at 60° C.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can effect two kinds of microbial cell damage. The first is a lethal, irreversible action resulting in complete microbial cell destruction or incapacitation. The second type of cell damage is reversible, such that if the organism is rendered free of the agent, it can again multiply. The former is termed microbiocidal and the later, microbistatic. A sanitizer and a disinfectant are, by definition, agents which provide antimicrobial or microbiocidal activity. In contrast, a preservative is generally described as an inhibitor or microbistatic composition.

As used herein, the term “commercial sterility,” refers to the absence of microorganisms capable of growing in a food or food product at non-refrigerated temperatures at which the food is likely to be held during manufacture, distribution and storage. Non-refrigerated temperatures refer to temperatures above about 42° F. Refrigerated temperatures refer to temperatures between about 35° F. and about 41° F.

In some aspects, the present invention provides methods for reconditioning a used food processing fluid for re-use in a food processing application. In some embodiments, the method includes recovering the fluid after it has been used, e.g., after it has been used in an application for food processing, e.g., a poultry chiller tank. This used fluid is hereinafter referred to as the “recovered fluid,” “recovered food processing fluid,” or “recovered used fluid.” Solid materials are then removed from the recovered fluid, and a combined reuse fluid with a desired level of antimicrobial agent is created. The combined reuse fluid is created by exchanging up to about 50% of the recovered volume of used fluid with an unused fluid and an effective amount of an antimicrobial agent. The effective amount of antimicrobial agent is based on a plurality of food processing parameters. The combined reuse fluid is suitable for use in a food processing application.

In some embodiments, the methods of the present invention provide for the reconditioning of fluids, e.g., water, previously used in a food processing application. The fluids suitable for reconditioning according to the methods of the present invention can be those used in any food processing application. In some embodiments, the fluids are those used in a washing, rinsing, preserving, sanitizing, disinfecting, sterilizing, harvesting, peeling, cutting, blanching, scalding, cooking, chilling, irrigating, flavoring, pickling, soaking, marinating, curing, coating, transporting, floating, separating, sorting and/or disposing food processing application. In other embodiments, the fluids are those used in a chiller bath, e.g., a poultry chiller bath.

In other embodiments, the methods of the present invention provide for the reconditioning of fluids used in applications associated with inanimate objects. For example, fluids used in heating/cooling, transporting, sanitizing, preserving, cutting, floating, sorting, recreational, fire-fighting, hydrating, lubricating, irrigating, flooding, and ballast solutions.

In some embodiments, the used food processing fluid is recovered after it has been used in a food processing application. The used food processing fluid can be recovered from any of a number of desired sources including, but not limited to, carcass chiller bath water, carcass wash water, carcass scald water and carcass defeathering water. The used food processing fluid can also be recovered from food transport water, food wash water, food sanitizing/disinfecting/sterilizing water, conveyor belt wash water, conveyor sanitizing/disinfecting/sterilizing water, equipment wash water, equipment sanitizing/disinfecting/sterilizing water, package wash water, food packaging rinse water, and package sanitizing/disinfecting/sterilizing water. In some embodiments, the food processing fluid is recovered from a chiller tank. In other embodiments, the food processing fluid is recovered from more than one chiller tank, e.g., from two, three or four chiller tanks.

The recovered food processing fluids then flow and/or are pumped to a selected solids separation or screening device. Solid materials are then substantially removed from the recovered food processing fluids. In some embodiments, up to about 99% of un-dissolved solid materials are removed from the recovered food processing fluids. Solid materials to be removed from the food processing fluids include, but are not limited to, pieces of poultry or meat that have separated from the food product being processed, blood, non-food debris, feathers, hairs, twigs, pebbles, organic chemical compounds, inorganic chemical compounds, fats, oils, and greases. The solid materials can be removed from the recovered food processing in a variety of ways. In some embodiments, the solid materials are removed using a separation method selected from the group consisting of filtration, centrifugation, flotation, flocculation, coagulation, purging, and combinations thereof.

Any apparatus suitable for removing solid materials from the food processing fluid can be used with the methods of the present invention. Suitable apparatuses include, but are not limited to: a screen, e.g., a rotary drum screen; a filter, e.g., an ultra-filtration membrane; a spillway, e.g., a wier; and a dissolved air flotation device. Other exemplary apparatuses suitable for removal of solid materials from the food processing fluid include, but are not limited to, activated carbon filtration devices, fluidized bed filtration devices, sand filtration devices, and ion exchange devices.

In some embodiments, a dissolved air floatation device is used. In some embodiments, the ability of the selected apparatus to remove solids can be enhanced by the addition of a chemical or chemicals to improve the coagulation and flocculation of particulate matter. In some embodiments, the chemical added to improve the coagulation or flocculation is selected from the group consisting of aluminum salts, ferric salts, activated silica, organic polymers, inorganic polymers, and combinations thereof.

Once a substantial amount of the solid materials have been removed from the recovered food processing fluid, a combined reuse fluid is created. As used herein, the term “combined reuse fluid” refers to a fluid created by exchanging a portion of a recovered food processing fluid with a portion of an unused fluid, and an effective amount of an antimicrobial agent. The combined reuse fluid is suitable for use in a variety of applications, including but not limited to, food processing applications.

In some embodiments, the combined reuse fluid is used in the same food processing application as the food processing application from which the used fluid was recovered. For example, in some embodiments, water from a poultry chilling tank is recovered and a combined reuse fluid is created according to the methods of the present invention. The combined reuse fluid is then used in a poultry chilling tank.

In other embodiments, the combined reuse fluid is used in a different food processing application as the food processing application from which the used fluid was recovered. For example, in some embodiments, water from an inside/outside bird washer is recovered and a combined reuse fluid is created according to the methods of the present invention. The combined reuse fluid can then be used in any other food processing application desired, e.g., in a scalding application, in a rinsing application, or a transporting application. In some embodiments, the combined reuse fluid can be used in upstream processing application. In other embodiments, the combined reuse fluid can be used in a downstream processing application.

In some embodiments, about 1% to about 50% of the recovered food processing application fluid is exchanged with an unused fluid. In other embodiments, about 10% to about 40% of the recovered food processing application fluid is exchanged with an unused fluid. In still yet other embodiments, about 20% to about 30% of the recovered food processing application fluid is exchanged with an unused fluid. It is to be understood that all values and ranges between these values and ranges are encompassed by the present invention.

The pH of the combined reuse fluid is controlled such that the antimicrobial agent added is effective at reducing the viable microorganism count in the combined reuse fluid. The pH of the combined reuse fluid is dependent on a variety of factors including, but not limited to, the temperature of the reuse fluid, the microorganism present, and the antimicrobial agent selected. In some embodiments, the pH of the combined reuse fluid is between about 4 and about 8. In some embodiments, the pH of the combined reuse fluid is about 7. It is to be understood that all ranges and values between these ranges and values are encompassed by the methods of the present invention.

The unused fluid added to create the combined reuse fluid can be derived from a variety of sources. For example, in some embodiments, the unused fluid is water. The water added can be from a municipal water source, or private water system, e.g., a public water supply or a well. The water can be city water, well water, water supplied by a municipal water system, water supplied by a private water system, and/or water directly from the system or well. In some embodiments, the unused fluid can comprise water-containing processing fluids. For example, the unused fluid can include marinades, or flavorings.

The combined reuse fluid also includes an effective amount of an antimicrobial agent. As used herein, the term “effective amount of antimicrobial agent” refers to an amount of antimicrobial agent sufficient to reduce the microbial population in the combined reuse fluid such that the final quality of fluid is safe for its intended use, e.g., as a carcass or bird chiller makeup water, evisceration wash water, inside/outwash water, sanitation cleanup water, or at any other point of use.

In some embodiments, an effective amount is an amount effective to reduce the viable microbial population in the combined reuse fluid by at least about 50%, by at least about 75%, or by at least about 90%. In still yet other embodiments, an effective amount is an amount effective to reduce the viable microbial population in the combined reuse fluid by at least about 99 to about 99.999%, i.e., about a 2 log reduction to about a 5 log reduction. It is to be understood that all values and ranges between these values and ranges are encompassed by the methods of the present invention.

In some embodiments, the effective amount of antimicrobial agent added to the combined reuse fluid is dependent on a plurality of food processing parameters. The food processing parameters can be measured using art-recognized techniques that provide the desired information and/or by using techniques or methods described herein. Examples of food processing parameters that can be used include, but are not limited to, a targeted level of microorganism inactivation, a targeted time for fluid reconditioning, the temperature of the used food processing fluid, the decay of the antimicrobial agent in the combined reuse fluid and combinations thereof.

Any number of food processing parameters can be measured. For example, the plurality of food processing parameters measured can be two, three, or four food processing parameters. The combination of particular food processing parameters selected depends on a variety of factors. For example, the food processing parameters selected may depend on the food processing application from which the used fluid was recovered from and/or the type of food product that was processed.

In some embodiments, a selected food processing parameter includes the targeted level of microorganism inactivation. The targeted level of microorganism inactivation can be measured as a reduction in the number of viable microorganisms per unit volume. For example, in some embodiments, the targeted level of microorganism inactivation is a reduction in the number of colony forming units per milliliter (CFU/mL). In some embodiments, the targeted level of microorganism inactivation is between about a 0.10 and about a 12.0 Log₁₀ reduction in viable microorganism numbers per unit volume, or about a 0.1 and about a 5.0 Log₁₀ reduction in viable microorganism numbers per unit volume. In other embodiments, the targeted level of microorganism inactivation is between about a 0.5 and about a 4.0 Log₁₀ reduction. The targeted level of microorganism inactivation can also be a reduction that results in the absence of microorganisms capable of growing in a food or food product under non-refrigerated conditions, such as those conditions under which the food or food product is likely to be held during manufacture, distribution, and/or storage.

In other embodiments, a selected food processing parameter includes the targeted time for fluid reconditioning. The term “targeted time for fluid reconditioning” refers to the amount of time that the antimicrobial agent is in contact with the recovered used food processing fluid, and the unused fluid in the combined reuse fluid, prior to the combined reuse fluid being used in a food processing application. In some embodiments, the targeted time for fluid reconditioning is greater than about 30 minutes. In some embodiments, the targeted time for fluid reconditioning is about 0.25 minutes to about 30 minutes. In other embodiments, the targeted time for fluid reconditioning is about 0.5 to about 15 minutes. It is to be understood that all values and ranges between these values and ranges are encompassed by the methods of the present invention.

In other embodiments, the selected food processing parameter includes the temperature of the recovered used food processing fluid. The temperature of the recovered used fluid depends on a variety of factors including, but not limited to, the food processing application from which the fluid was recovered from. For example, water used in a poultry chilling tank is between about 1° C. and about 10° C., whereas water used in an inside/outside birdwasher is between about 4° C. and about 40° C. In some embodiments, the temperature of the recovered used food processing fluid is about −10° C. and about 100° C., about 20° C. and about 80° C., or about 40° C. and about 60° C. It is to be understood that all ranges and values between these ranges and values are encompassed by the methods of the present invention.

In some embodiments, the selected food processing parameter includes the decay of the antimicrobial agent in the combined reuse fluid. The decay of the antimicrobial agent ordinarily depends on the level of organic and inorganic materials in the process fluid. For example, the fluid may contain protein, carbohydrate, lipid, calcium carbonate, iron, manganese, nitrogen, and/or chlorine. In some embodiments, the level of the antimicrobial agent is increased to compensate for decay during reconditioning caused by the unused processing fluid. This is referred to as “initial demand.” In other embodiments, the level of the antimicrobial agent is increased to compensate for decay during the reconditioning process caused by contaminates in the recovered used processing fluid. This is referred to as the “organic demand,” although the contaminants can comprise both organic and inorganic matter.

In some embodiments, the effective amount of antimicrobial agent is based on a combination of food processing parameters including: a targeted level of microorganism inactivation; a targeted time for fluid reconditioning; the antimicrobial agent selected and the temperature of the recovered used food processing fluid.

In some embodiments, the effective amount of the antimicrobial agent for a targeted level of microorganism kill and targeted temperature is calculated using the equation C=(k/t)^{1/n} where “C” is the level of antimicrobial agent, “t” is the targeted time for reconditioning and “k” and “n” are constants. The constants k and n are derived as follows. First, the viability of the microorganism as a function of time is established. The viability is determined by exposing the microorganism to different levels of the antimicrobial agent at a targeted temperature. This relationship is then modeled using a logistic function. The logistic function models are also used to calculate the exposure times needed to provide the targeted level of efficacy (e.g., a 1 Log₁₀ reduction) at the different levels of the antimicrobial agent, and for the targeted level of efficacy. Finally the relationship between antimicrobial agent level and exposure time is modeled using the power function y=a·x^{b}. The term “a” in the function corresponds to “k”, and the absolute value of the term “b” corresponds to the term “n”.

For example, when the food processing parameters selected are: a targeted level of microorganism inactivation; a targeted time for fluid reconditioning; and the temperature of the recovered food processing fluid; and the antimicrobial agent selected is peroxyacetic acid (POAA), an effective amount of POAA is greater than the amount described by the following formula:

Y=(((11.664*a)+14.16)/b)̂(1/(1.0712*(â−0.0485)))*2.3688*EXP(−0.0347*c)

wherein,

Y=level of antimicrobial agent in parts per million;

a=targeted level of microorganism inactivation;

b=targeted time for fluid reconditioning; and

c=the temperature of the used food processing fluid.

It should be noted that as used in this formula, “*” is used to indicate multiplication, “̂” is used to indicate an exponent, and “EXP” is used to indicate raising the natural logarithm to the specified power.

For example, in some embodiments, one of skill in the art can measure the targeted level of microorganism inactivation, the targeted time for fluid reconditioning; and the temperature of the used food processing fluid. Using the above described formula, an effective amount of antimicrobial agent necessary for reconditioning the used fluid can be determined. That is, the effective amount of antimicrobial agent necessary for reconditioning the fluid such that it is suitable for the desired end use can be determined.

The present invention allows for the reconditioning and reuse of food processing fluids in a more economical manner than other conventional reconditioning processes. That is, the current methods and systems only require the addition of an antimicrobial agent at one stage during the reconditioning process, viz. the formation of the combined reuse fluid. Although additional antimicrobial agent may be added at other stages in the process, it is not a required step to recondition the recovered fluids. Thus, based on using a plurality of food processing parameters to determine an effective amount of antimicrobial agent, the present methods and systems can provide a reconditioned food processing fluid in an economical manner.

Any antimicrobial agent suitable for use in the desired end use application can be used with the methods of the present invention. In some embodiments, one antimicrobial agent is used. In other embodiments, two, three or four antimicrobial agents are used. For example, the antimicrobial agent or agents can include, but are not limited to: peroxygen compounds, ozone, chlorine dioxide, acidified sodium chlorite, chlorine, chlorine releasing agents, bromine releasing agents, quaternary ammonium compounds, cetylpyridinium chloride, organic acids, and mixtures thereof. In some embodiments, chlorine, or a chlorine containing compound is not used.

In some embodiments, a non chemical antimicrobial agent is used. For example, in some embodiments, UV radiation is used as an antimicrobial agent. Ozone may or may not be used as an antimicrobial agent.

In some embodiments, a peroxygen compound is used. Peroxygen compounds suitable for use in the present invention include, but are not limited to, peroxyacetic acid, peroxyoctanoic acid, peroxyformic acid, peroxypropionic acid, peroxyheptanoic acid, peroxybenzoic acid, peroxynonanoic acid, monoperglutaric acid, diperglutaric acid, succinylperoxide, hydrogen peroxide, and mixtures thereof.

In some embodiments, the antimicrobial solution is a peroxyacid mixture including acetic acid, octanoic acid, hydrogen peroxide, peroxyacetic acid, peroxyoctanoic acid, and 1-hydroxyethylidene-1,1-diphosphonic acid with the trade name INSPEXX 100. In other embodiments, the antimicrobial solution is selected from a group of non-chlorine halogen compounds including, but not limited to: iodines, iodophors, bromines, brominated compounds, and mixtures thereof. In some embodiments, the antimicrobial agent or agents used are substantially chlorine free.

In still yet other embodiments, the antimicrobial solution is selected from a group of quaternary ammonium compounds including, but not limited to: quaternary ammonium chlorides, cetylpyridinium chloride, and mixtures thereof. Organic acids (e.g., lactic acid, citric acid, propionic acid), mineral acids (e.g., phosphoric acid, hydrochloric acid, sulfuric acid), and mixtures thereof are also suitable for use in the methods and systems of the present invention. In still yet other embodiments, the antimicrobial solution includes sodium metasilicate, potassium metasilicate, and mixtures thereof.

The methods, systems and apparatus of the present invention are suitable for reconditioning food processing fluids contaminated with a variety of microorganisms. For example fluids containing bacteria, fungi, parasites, protozoa and combinations thereof can be reconditioned in accordance with the present invention. In some embodiments, the microorganism is selected from the group consisting of Acinetobacter, Aeromonas, Alcaligenes, Bacillus, Campylobacter, Clostridium, Enterococcus, Flavobacterium, Lactococcus, Lactobacillus, Leuconostoc, Listeria, Micrococcus, Moraxella, Pediococcus, Pseudomonas, Shewanella, Staphylococcus, Vibrio, Streptococcus, Salmonella, Escherichia, Citrobacter, Enterobacter, Erwinia, Klebsiella, Proteus, Serratia, Shigella, Yersinia, Alternaria, Aspergillus, Aureobasidium, Botrytis, Byssochlamys, Cladosporium, Fusarium, Geotrichum, Mucor, Penicillium, Rhizopus, Candida, Cryptococcus, Rhodotorula, Saccharomyces, Trichosporon, Zygosaccharomyces, Picorvaviruses, Reoviruses, Parvoviruses, Papovaviruses, Adenoviruses, Rotaviruses, Hepatitis A virus, Norwalk virus, Giardia, Entamoeba, Cryptosporidium, Toxoplasma, flatworms, roundworms, and combinations thereof.

After the food processing fluid has been reconditioned in accordance with the methods of the present invention, the fluid can be used in a further food processing application. In some embodiments, the reconditioned fluid is used in a chiller, e.g. a poultry chiller. The fluid can be re-chilled prior to being returned to the chiller tank.

The methods of the present invention can further include measuring the turbidity of the food processing fluid before, during and/or after the fluid has been reconditioned. That is, in some embodiments, the turbidity of the fluid can be measured before the solid materials are removed from the recovered used fluid and a combined reuse fluid is created. In other embodiments, the turbidity can be measured after the solid materials are removed from the recovered fluid, but before the combined reuse fluid is created. In other embodiments, the turbidity of the fluid can be measured after the fluid has been reconditioned in accordance with the methods of the present invention. In some embodiments, the turbidity of the reconditioned fluid is between about 0.5 NTU and about 50 NTU, wherein “NTU” refers to Nephelometric Turbidity Units. Generally, a turbidity no greater than 25 NTU's is acceptable after the fluid has been reconditioned.

The reconditioning systems can be placed in any desired location. In some embodiments, the systems can be placed within the same structure where the food processing application occurs. In other embodiments, the systems can be placed outside of the structure where the food processing application occurs.

In some aspects, the present invention provides for the use of multiple treatment systems. For example, in some embodiments, a plurality of chillers are used, e.g., 2, 3, or 4 chillers, in a food processing application. A plurality of reconditioning systems can then be used, e.g., 2, 3, or 4 reconditioning systems, to recondition the chiller water. That is, each chiller in the food processing plant can be equipped with a single treatment system, so that there is an equal number of chillers and treatment systems used. In other embodiments, one treatment system can be provided for multiple chillers.

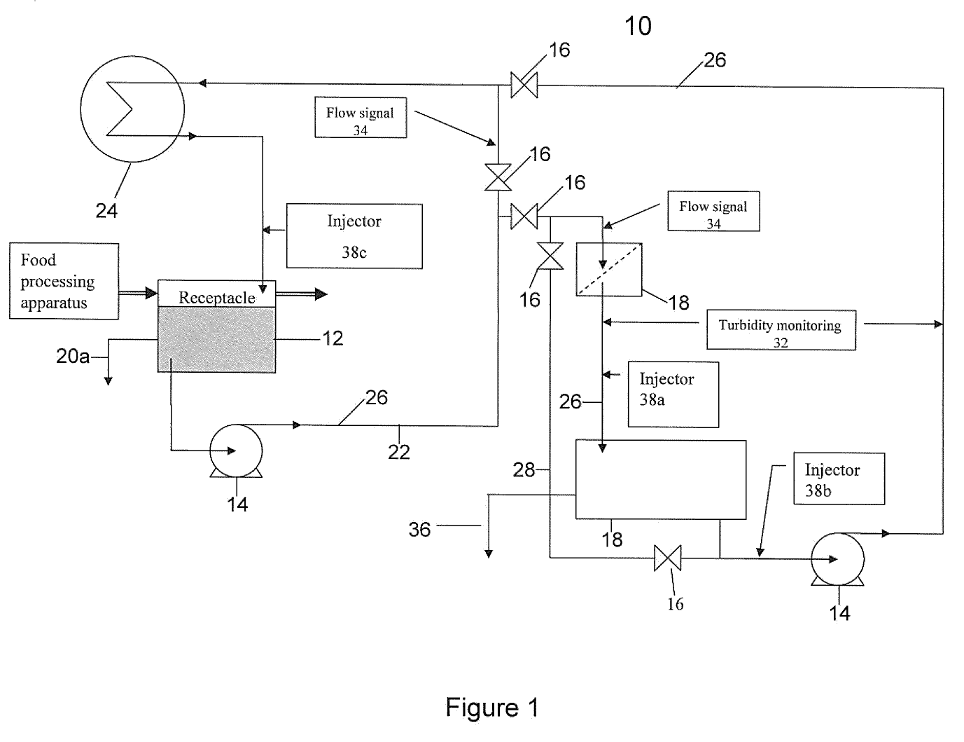

In some aspects, the present invention provides a system for reconditioning and re-use of a fluid used in an application for food processing. The system can be provided in a variety of configurations. FIG. 1 is a block diagram of an embodiment of a system 10 in accordance with the present invention. System 10 generally includes a first receptacle 12 for recovering the used food processing fluid after the fluid has been used in an application for food processing. Although shown as a single receptacle, in some embodiments the receptacle 12 includes a plurality of receptacles. In some embodiments, the receptacle 12 is a chiller tank or a plurality of chiller tanks.

In other embodiments, the system 10 does not include a first receptacle. That is, in some embodiments the used food processing fluid is recovered directly from the food processing application by flowing, and/or by being pumped into the system 10 directly from production.

The system 10 generally includes a circulation system 22 including piping 26 and a plurality of pumps 14 for circulating the fluid through the system. The system also includes a plurality of flow control devices 16. The flow control devices allow for the user to control the amount of fluid passing through the system 10. In some embodiments, the amount of fluid flowing through the system is between about 1 and about 1000 gallons per minute. In other embodiments, the amount of fluid flowing through the system is between about 100 and about 500 gallons per minute. In still yet other embodiments, the amount of fluid flowing through the system is about 200 gallons per minute. It is to be understood that all values and ranges between these values and ranges are encompassed by the methods of the present invention.

In some embodiments, the system 10 further includes a bypass line 28. The bypass line 28 can be used for a variety of functions. In some embodiments, the bypass line 28 is used during a clean in place process. That is, in some embodiments, a cleaning solution is passed through the system 10 using the bypass line 28. The bypass line 28 is positioned such that during cleaning, the cleaning solution does not pass through the apparatus or apparatuses 18 used for removing solid materials from the fluid.

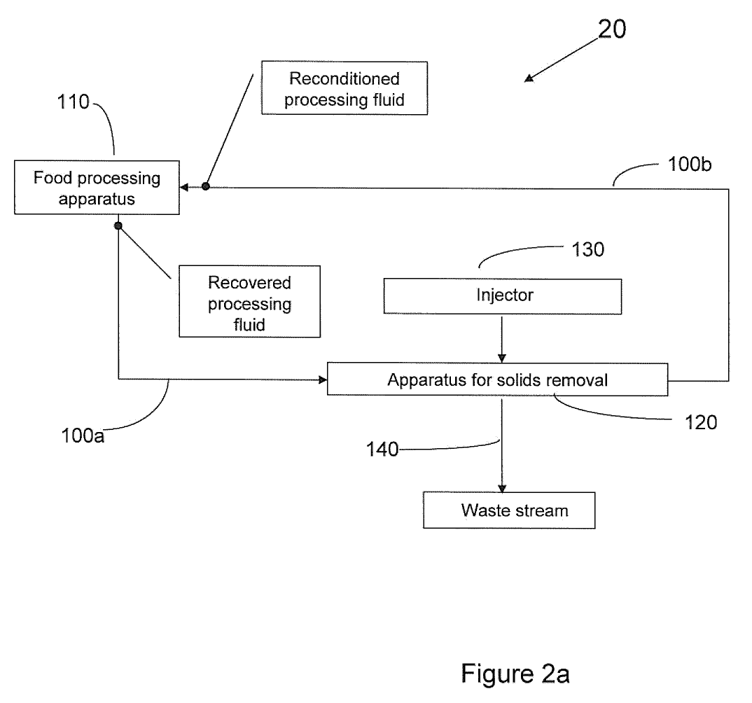

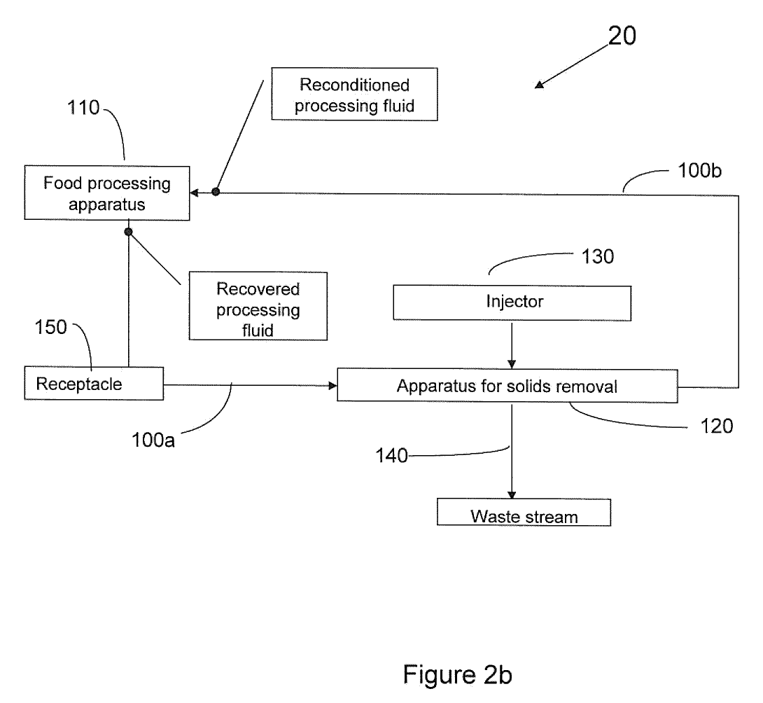

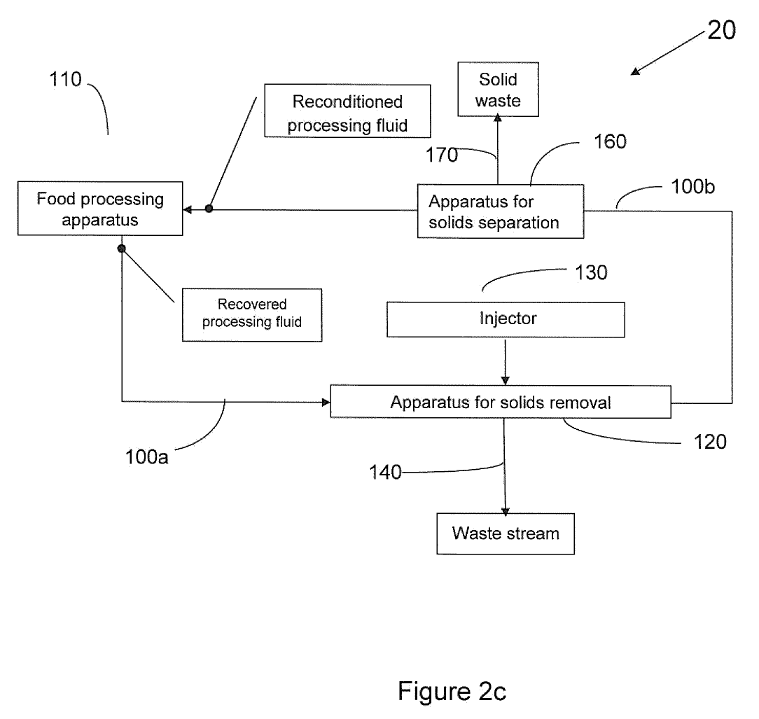

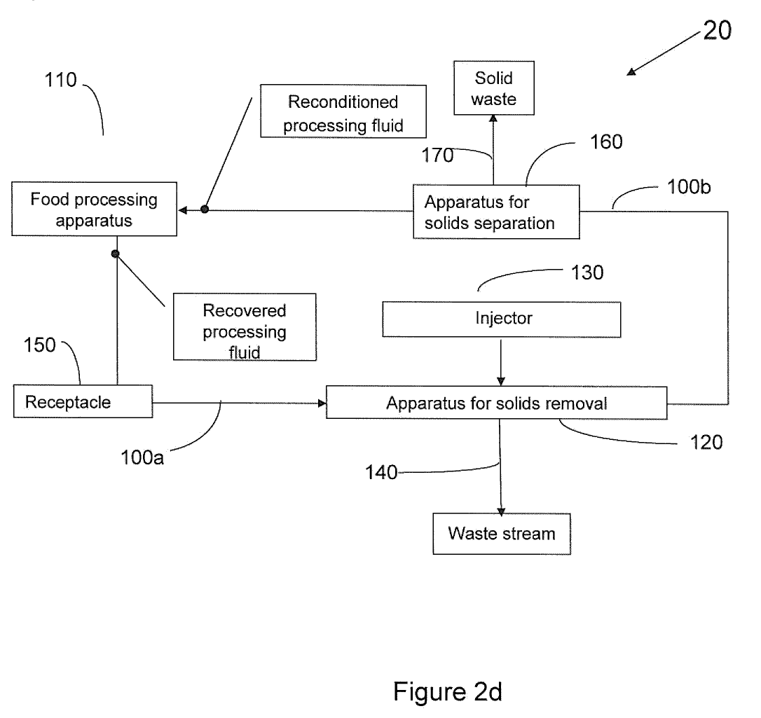

The system further includes an apparatus or apparatuses 18 for removing solid materials from the fluid. Although shown in FIG. 1 as including two apparatuses for removing solid materials from the fluid, in some embodiments, less than two or more than two apparatuses can be used in the system of the present invention. For example, FIGS. 2a and 2b show embodiments where only a single apparatus for removing solid materials is included in the system.

Any apparatus suitable for removing solid materials from the fluid to be reconditioned can be used. For example, the apparatus 18 can include, but is not limited to, a screen, a filter, a dissolved air floatation device, a dissolved air floatation device enhanced by the addition of chemicals to improve the flocculation of the solid material, a centrifuge and combinations thereof. The apparatus 18 can also include, but is not limited to, an activated carbon filtration device, a fluidized bed filtration device, a sand filtration device, an ion exchange device and combinations thereof.

Referring again to FIG. 1, in some embodiments, the apparatus 18 further includes a mechanism 36 for transporting solids from the fluid away from the apparatus. The mechanism can include a stationary mechanism, e.g., a channel and/or a moving mechanism, e.g., a skimmer, for transporting solids collected from the fluid away from the apparatus. The removed solids can be disposed of or can be further processed.

The system of the present invention can also include injectors 38. One or multiple injectors can be used. Injector 38a can be used for adding additional chemicals to enhance the removal of a solid, e.g., flocculants or coagulants. Additionally, in some embodiments, injector 38a is approved by the National Sanitation Foundation (NSF) for introducing potable water into the system. Injector 38b can be used to deliver an effective amount of antimicrobial agent, e.g., a peroxygen compound, and an unused fluid, e.g., potable water. Optionally, in some embodiments, a pH controlling agent and/or a generally recognized as safe (GRAS) substance can be added to the system through injector 38b.

The system of the present invention further includes an outlet 20a fluidly connected to the receptacle 12 for removing a portion of the recovered volume of used fluid, and an injector 38b for addition of an unused fluid, and an effective amount of an antimicrobial agent. The effective amount of antimicrobial amount is based on a plurality of food processing parameters. Examples of food processing parameters that can be used include, but are not limited to, a targeted level of microorganism inactivation, a targeted time for fluid reconditioning, the temperature of the used food processing fluid, the antimicrobial agent selected, the decay of the antimicrobial agent in the combined reuse fluid and combinations thereof.

In some embodiments, about 1% to about 50%, about 10% to about 40%, or about 20% to about 30% of the recovered used food processing application fluid is exchanged with an unused fluid via the injector 38b and the outlet 20a. In other embodiments, about 20% of the used food processing application fluid is exchanged with an unused fluid via the injector 38b and the outlet 20a. It is to be understood that all values and ranges between these values and ranges are encompassed by the methods of the present invention.

The system can further include, in some embodiments, injector 38c. Injector 38c can be used to add additional antimicrobial agents to the system. For example, in some embodiments, free chlorine, e.g., at least about 50 ppm of free chlorine can be added to the system through injector 38c. In other embodiments, a peroxygen compound, e.g., at least about 200 ppm of a peroxyacid can be added through injector 38c. Any antimicrobial agent suitable for use in the system of the present invention can be added through injector 38c.

In some embodiments, the system of the present invention further includes a rechiller 24 to chill the reconditioned water to a desired temperature. The system of the present invention can further include various flow signals 34, as well as monitors 32 to measure the turbidity of the fluid being reconditioned.

FIG. 2a is a block diagram of an embodiment of a reconditioning system 20 of the invention, showing piping 100, and an apparatus 120 for solids removal, fluid exchange and antimicrobial addition. The fluid used in food processing apparatus 110 is recovered, and piped to the apparatus 120. In some embodiments, the fluid is recovered directly from the food processing apparatus by flowing and/or being pumped into the system directly from the processing apparatus. An injector 130 is in fluid communication with the apparatus 120. The injector 130 is capable of providing an unused food processing liquid, e.g., water, and an antimicrobial agent to the apparatus 120. A waste stream outlet 140, in fluid communication with the apparatus 120 can also be included. A waste stream is drained from the apparatus 120 through the outlet 140.

A portion of the solids present in the recovered fluid from the food processing apparatus 110 are filtered out by the apparatus 120 and removed from the system through the outlet 140. A portion of the recovered fluid is also removed from the system through the outlet 140. In some embodiments, up to about 50% of the recovered fluid is removed from the system through the waste stream outlet 140.

The portion of recovered fluid to be removed from the system can be removed at anytime. For example, the portion of recovered fluid to be removed can be removed before, during or after the antimicrobial agent, and unused fluid are added to form a combined reuse fluid. Piping 100b returns the combined reuse fluid to a food processing apparatus 110. The combined reuse fluid can be returned to the same food processing apparatus from which it was recovered from or to a different food processing apparatus than that from which it was recovered.

As is shown in FIG. 2b, in some embodiments, the system can further include a receptacle 150 fluidly connected between the food processing apparatus 110, and the apparatus for solids removal 120. The used processing fluid can be recovered, viz. collected, in the receptacle 150 after it has been used in food processing apparatus 110. The used processing fluid can be held in the receptacle 150 for a desired amount of time, prior to being provided to the apparatus for solids removal.

Referring to FIGS. 2a through 2d, an antimicrobial agent and an unused processing fluid, e.g., water, can be injected into the recovered processing fluid through the injector 130 while the recovered processing fluid is passing through the apparatus for solids removal 120. Solids removed from the recovered processing fluid, and a portion of the recovered processing fluid can be removed from the reconditioning system through the outlet 140.

After the solids removal, and exchange of fluids (e.g., disposal of a portion of the recovered processing fluid and addition of antimicrobial agent and unused fluid), the resulting fluid, viz. the combined reuse fluid, is provided via piping 100b to a food processing apparatus 110. The food processing apparatus may be the same or different than the food processing apparatus from which the processing fluid was recovered from.

As is shown in FIG. 2c, in some embodiments, the system can further include a separate, additional apparatus for solids separation 160. The additional apparatus for solids separation 160 can be fluidly connected between the first apparatus for solids removal 120 and the food processing apparatus to which the combined reuse fluid is provided. The additional apparatus for solids separation 160 can also include an outlet 170 through which additional solids removed from the combined reuse fluid by the apparatus 160 can be disposed of.

The additional apparatus for solids separation 160 can be of the same, or of a different type than the apparatus for solids removal 120. For example, the apparatus for solids removal 120 can be a screen, and the additional apparatus for solids separation 160 can be a filter. In other embodiments, both the apparatus for solids removal 120 and the additional apparatus for solids separation 160 can be a screen, for example. Any apparatus suitable for removing solid materials from the food processing fluid can be used as either apparatus 120 or 160. Suitable apparatuses include, but are not limited to: a screen, e.g., a rotary drum screen; a filter, e.g., an ultra-filtration membrane; a spillway, e.g., a wier; and a dissolved air flotation device.

In some embodiments, as shown for example in FIG. 2d, the system can include both a receptacle 150 and an additional apparatus for solids separation 160. The receptacle 150 can be fluidly connected between the food processing apparatus 110 and the apparatus for solids removal 120.

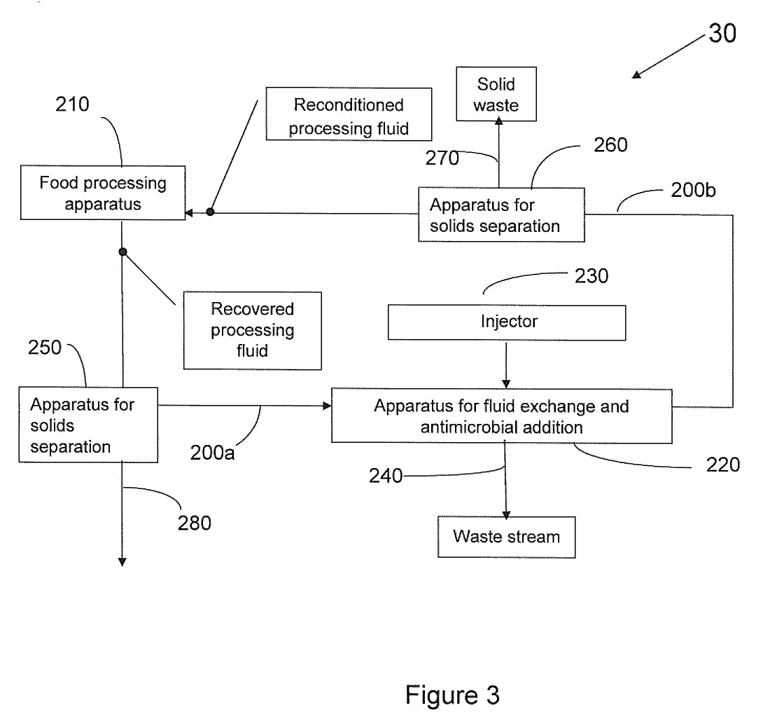

FIG. 3 is a block diagram of an embodiment of a reconditioning system 30 of the invention, showing piping 200, a first apparatus for solids separation 250, an apparatus for fluid exchange and antimicrobial addition 220, and an additional apparatus for solids separation 260. A first apparatus for solids separation 250 is fluidly connected between a food processing apparatus 210 and the apparatus for fluid exchange and antimicrobial addition 220. The first apparatus for solids separation 250 can also include an outlet 280 for removing solids collected during the separation process from the recovered processing fluid.

The recovered processing fluid is then provided to an apparatus for fluid exchange and antimicrobial addition 220. In some embodiments, the apparatus 220 is a holding tank that allows for the removal of a portion of the recovered fluid, and for the addition of an unused fluid and an effective amount of antimicrobial agent. The size of the tank impacts the amount of time the combined reuse fluid remains in the tank. That is, the size of the tank impacts the antimicrobial exposure time in order to ensure proper reconditioning of the recovered fluid. In some embodiments, the larger the tank, the longer the fluid remains in the tank.

The apparatus for fluid exchange and antimicrobial addition 220 can also include an injector 230 capable of providing an unused fluid, e.g., water, and an antimicrobial agent, e.g., a peracid, to the recovered processing fluid. The apparatus 220 can also include an outlet 240 for removing a portion of the recovered processing fluid. In some embodiments, up to about 50% of the recovered processing fluid is removed through the outlet 240. The removal of the recovered fluid can occur before, after, or substantially simultaneously as the addition of unused processing fluid and antimicrobial agent.

The remaining recovered fluid and the added unused fluid and antimicrobial agent, viz. the combined reuse fluid, is then provided to the additional apparatus for solids separation 260 via piping 200b. The additional apparatus for solids separation 260 can include an outlet 270 capable of removing solid waste resulting from the separation process. The additional apparatus for solids separation 260 can be the same, or different than the apparatus for solids removal 220.

After passing though the additional apparatus for solids separation 260, the reconditioned processing fluid is provided to a food processing apparatus 210. The food processing apparatus can be the same or different the food processing apparatus from which the used processing fluid was recovered.

### EXAMPLES

The present invention is more particularly described in the following examples that are intended as illustrations only. Unless otherwise noted, all parts, percentages, and ratios reported in the following examples are on a weight basis, and all reagents used in the examples were obtained, or are available, from the chemical suppliers described below, or may be synthesized by conventional techniques.

### Example 1

### Evaluation of Parameters for Microorganism Inactivation

Parameters for inactivation of a selected microorganism suspended in water, Salmonella enterica serotype Typhimurium (i.e., Salmonella Typhimurium), were studied.

For testing on each day, a Salmonella enterica serotype Typhimurium ATCC 13311 culture was propagated by incubating for 18-24 hours at 35° C. in Nutrient broth. Culture was centrifuged at 10,000 rpm for 10 minutes, the supernatant removed, and the culture pellet was re-suspended in the same quantity of sterile deionized water. The washed culture was used for testing within about 1 hour of preparation. Washed culture density ranged from 8.75 to 9.43 log₁₀ CFU/mL.

Working solutions were prepared by adding a solution of 15 wt % peroxyacetic acid (POAA) to 500 g of sterile deionized water to achieve the target POAA concentration. Sodium hydroxide or phosphoric acid was added in 10 to 20 μL increments to POAA solutions to result in a final pH of 4, 5, 7, 8, or 9. The pH and POAA concentration were stable during the duration of the efficacy test (usually about 1 hour). For tests involving organic “soil,” ground animal feed (about 25% crude protein, 25% crude fiber) was added at 10% (by wt) to sterile deionized water. The day prior to testing, the POAA solution was added to the soil-water suspension to overcome the POAA demand (about 50 mg POAA per 100 g soil-water suspension) and resulted in a stable 10 ppm POAA residual that was confirmed on the day of testing.

One (1) milliliter of the washed culture was added to 99 mL of working solution in a 250-mL Erlenmeyer flask while mixing. This resulted in approximately 7 log₁₀ CFU/mL in the working solution. After the desired exposure time, 1 mL of the suspension was removed and transferred to 9 mL of D/E neutralizing broth. Survivors were quantified by plating 1 mL of the 10⁰ sample (undiluted D/E) onto Tryptone Glucose Extract (TGE) agar and incubating for 48 h at 35° C. In addition to plating the 10⁰ dilution, 100-fold serial dilutions (10⁻³ and 10⁻⁵) were prepared in phosphate buffered water and plated as described above.

Survivor counts were tabulated and log-transformed to approximate a normal distribution. To negate the effects of small differences in starting numbers, the proportion of survivors over starting numbers (N/N₀) was plotted versus exposure time. The sigmoidal shape of the S. Typhimurium inactivation curve was modeled using a four parameter logistic model (XLSTAT version 2007.1, Addinsoft™). The four parameter logistic model writes:

$$y = a - \frac{d - a}{1 + {( x / c )}^{b}}$$

In this model, a, b, c, and d are the parameters. The letter ‘x’ corresponds to the explanatory variable and ‘y’ to the response variable. The letters ‘a’ and ‘d’ are the parameters that represent the lower and upper asymptotes, respectively. The letter ‘b’ is the slope parameter. The letter ‘c’ is the abscissa of the mid-height point which is the ordinate (a+b)/2.

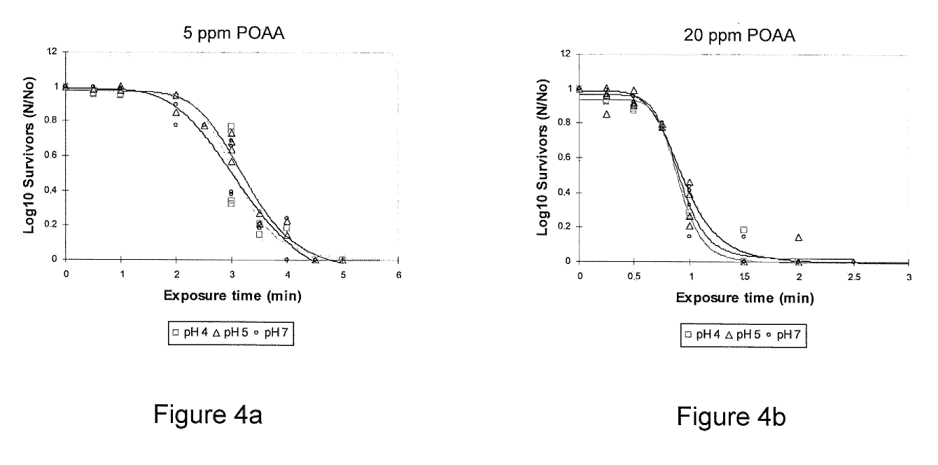

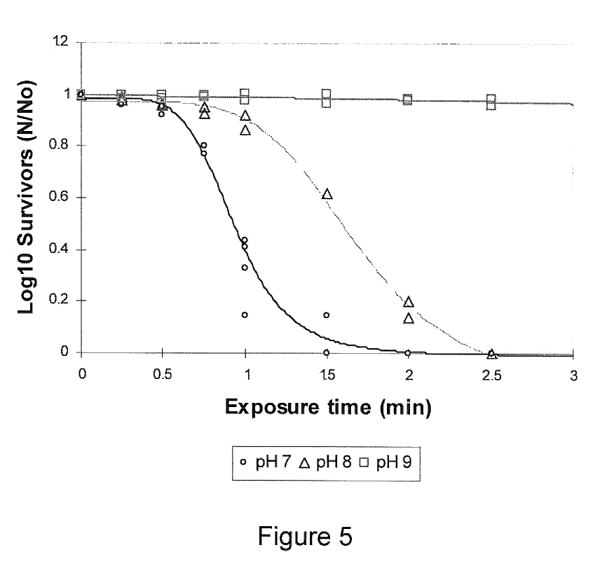

The impact of pH of the POAA solution on the reduction of the microorganism count was first evaluated. Testing at 5 and 20 ppm POAA showed no difference in inactivation rates at pH 4 to 7. FIG. 4 graphically depicts the results of this test. FIG. 4a shows the results when 5 ppm POAA was used, and FIG. 4b shows the results when 20 ppm POAA was used. However, as can be seen in FIG. 5 testing at 20 ppm POAA showed a reduction of efficacy at pH 8 and a complete loss of efficacy at pH 9.

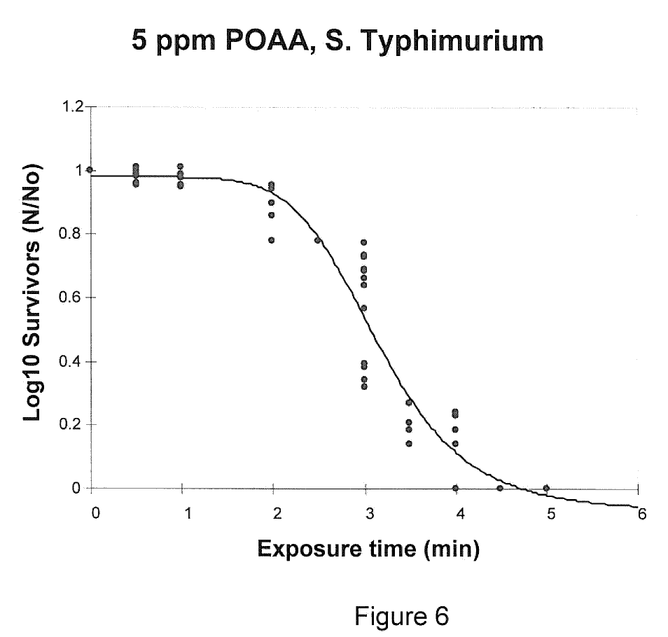

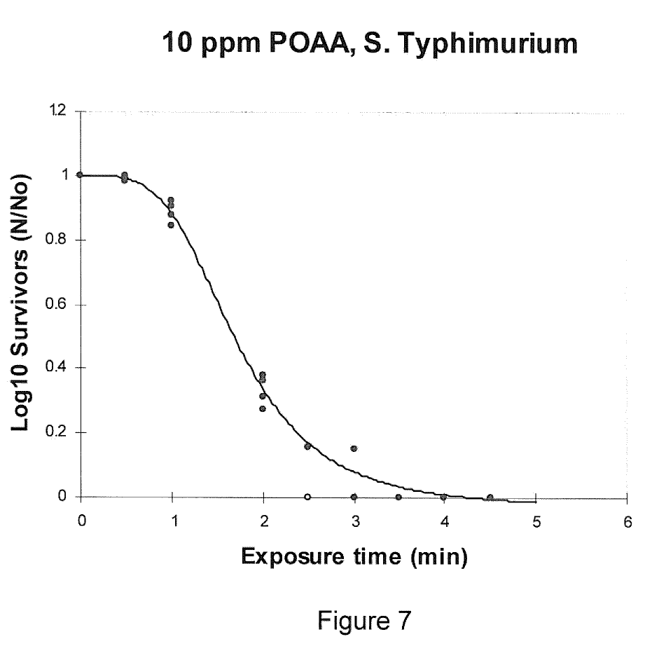

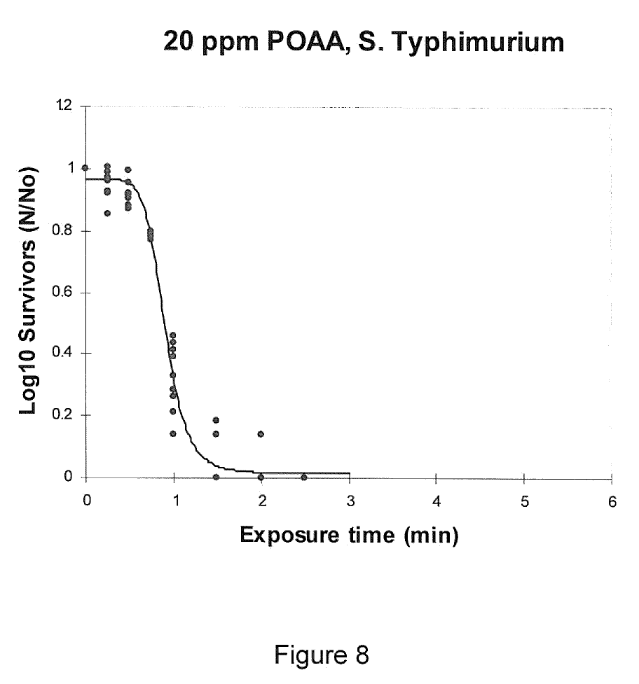

The impact of the concentration of the POAA solution on the reduction of the microorganism count was also evaluated. FIGS. 6, 7, 8 and 9 graphically depict these results. As can be seen from these figures, an increase in the concentration of antimicrobial agent, e.g., POAA, resulted in a reduction in the number of survivors over a shorter period of time.

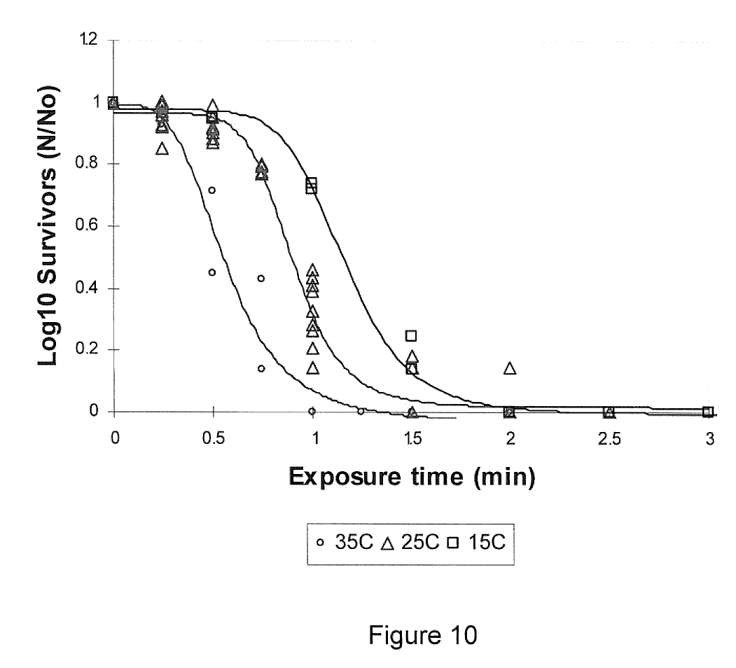

The impact of 10° C. (18° F.) temperature changes on the efficacy of 20 ppm POAA was also evaluated. FIG. 10 graphically depicts the results of this evaluation. As can be seen from FIG. 10, as the temperature was increased there was a reduction in the number of survivors over a short period of time.

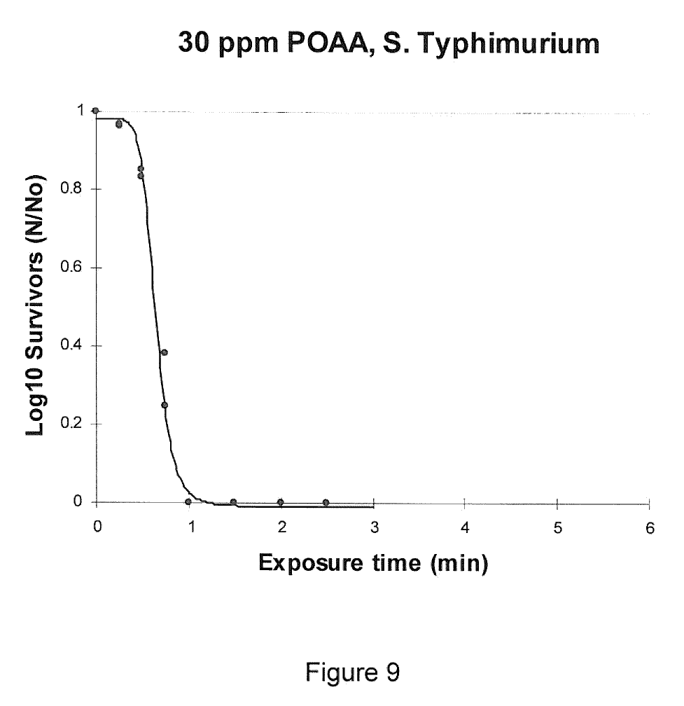

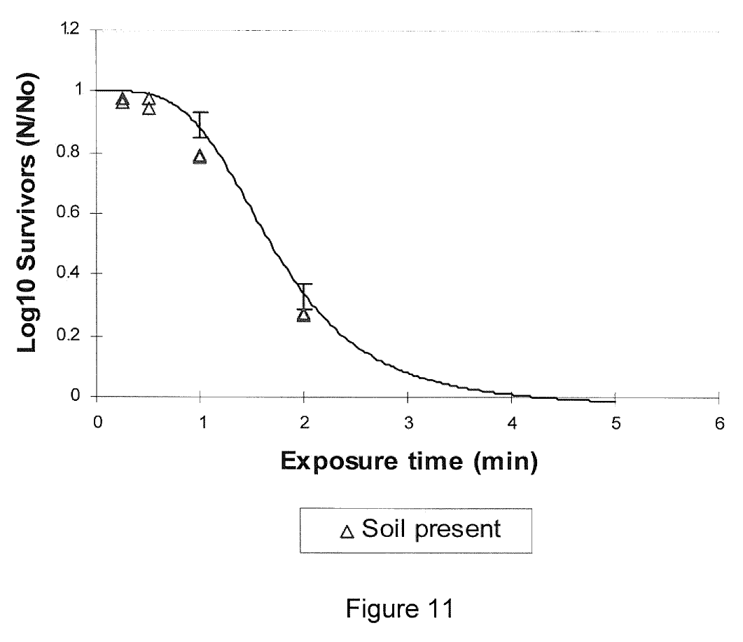

The impact of organic residue was also evaluated. Additional POAA must be added to overcome the ‘organic demand’ in soiled water, however, once the demand is satisfied, there is no reduction in efficacy. In fact, a slight improvement in efficacy was detected in the area of the kill curve near the inflection point. FIG. 11 graphically depicts the inactivation curve for 10 ppm POAA at 25° C., pH 4-7 with 99% confidence interval bars added at 1 and 2-min time points. The curved line shown in FIG. 11 represents the kill curve with no soil. Errors bars show 99% CI. The triangles in FIG. 9 show data when soil was present.

Overall this data was used to arrive at the following formula:

Y=(((11.664*a)+14.16)/b)̂(1/(1.0712*(â−0.0485)))*2.3688*EXP(−0.0347*c)

wherein,

Y=level of antimicrobial agent in parts per million;

a=targeted level of microorganism inactivation;

b=targeted time for fluid reconditioning; and

c=the temperature of the used food processing fluid.

This formula can be used to determine the effective amount of an antimicrobial agent for use with the methods and systems of the present invention.

### Other Embodiments

It is to be understood that while the invention has been described in conjunction with the detailed description thereof, the foregoing description is intended to illustrate, and not limit the scope of the invention, which is defined by the scope of the appended claims. Other aspects, advantages, and modifications are within the scope of the following claims.

In addition, the contents of all patent publications discussed supra are incorporated in their entirety by this reference.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

We claim:

1. A method for reconditioning a used food processing fluid for use in a food processing application, the method comprising:
(a) recovering the used fluid from a food processing application;
(b) removing a solid material present in the recovered used fluid; and
(c) creating a combined reuse fluid by exchanging about 1% to about 50% of the recovered volume of used fluid with:
(i) an unused fluid;
(ii) and an effective amount of an antimicrobial agent,
wherein the effective amount of antimicrobial agent is based on a plurality of food processing parameters, and the combined reuse fluid is suitable for use in a food processing application.

2. The method of claim 1, wherein the food processing parameters are selected from the group consisting of: a targeted level of microorganism inactivation; a targeted time for fluid reconditioning; the temperature of the used food processing fluid; the antimicrobial agent selected; decay of the antimicrobial agent in the combined reuse fluid; and combinations thereof.

3. The method of claim 2, wherein the targeted level of microorganism inactivation is a reduction between about a 0.10 and about a 12.0 Log₁₀ reduction in viable microorganism numbers per unit volume.

4. The method of claim 2, wherein the targeted level of microorganism inactivation is a reduction that results in the absence of microorganisms capable of growing in a food at a non-refrigerated temperature.

5. The method of claim 2, wherein the targeted time for fluid reconditioning is between about 0.5 minutes and about 15 minutes.

6. The method of claim 2, wherein the temperature of the used food processing fluid is between about −10° C. and about 100° C.

7. The method of claim 1, wherein the solid material is removed from the recovered used fluid using a separation method selected from the group consisting of filtration, centrifugation, settling, flotation, flocculation, coagulation, and combinations thereof.

8. The method of claim 1, wherein the used food processing fluid was used in a food processing application selected from the group consisting of washing, rinsing, preserving, sanitizing, disinfecting, sterilizing, harvesting, peeling, cutting, blanching, scalding, cooking, chilling, irrigating, flavoring, pickling, soaking, marinating, curing, coating, transporting, floating, separating, sorting, disposing and combinations thereof.

9. The method of claim 1, wherein the used food processing fluid was used in a food processing application comprising a food packaging rinse application.

10. The method of claim 1, wherein the antimicrobial agent comprises a peroxygen compound.

11. The method of claim 10, wherein the peroxygen compound is selected from the group consisting of peroxyacetic acid, peroxyoctanoic acid, peroxyformic acid, peroxypropionic acid, peroxyheptanoic acid, peroxybenzoic acid, peroxynonanoic acid, monoperglutaric acid, diperglutaric acid, succinylperoxide, hydrogen peroxide, and mixtures thereof.

12. The method of claim 2, wherein the microorganism is selected from the group consisting of bacteria, fungi, parasites, protozoa, and combinations thereof.

13. The method of claim 12, wherein the microorganism is selected from the group consisting of Acinetobacter, Aeromonas, Alcaligenes, Bacillus, Campylobacter, Clostridium, Enterococcus, Flavobacterium, Lactococcus, Lactobacillus, Leuconostoc, Listeria, Micrococcus, Moraxella, Pediococcus, Pseudomonas, Shewanella, Staphylococcus, Vibrio, Streptococcus, Salmonella, Escherichia, Citrobacter, Enterobacter, Erwinia, Klebsiella, Proteus, Serratia, Shigella, Yersinia, Alternaria, Aspergillus, Aureobasidium, Botrytis, Byssochlamys, Cladosporium, Fusarium, Geotrichum, Mucor, Penicillium, Rhizopus, Candida, Cryptococcus, Rhodotorula, Saccharomyces, Trichosporon, Zygosaccharomyces, Picorvaviruses, Reoviruses, Parvoviruses, Papovaviruses, Adenoviruses, Rotaviruses, Hepatitis A virus, Norwalk virus, Giardia, Entamoeba, Cryptosporidium, Toxoplasma, flatworms, roundworms, and combinations thereof.

14. The method of claim 1, wherein the pH of the combined reuse fluid is between about 4 to about 8.

15. The method of claim 1, wherein the effective amount of the antimicrobial agent is based on a plurality of food processing parameters comprising a targeted level of microorganism inactivation; a targeted time for fluid reconditioning; and the temperature of the used food processing fluid.

16. The method of claim 1, further comprising providing the combined reuse fluid to a food processing application.

17. The method of claim 16, wherein the combined reuse fluid is provided to the same food processing application from which the used fluid was recovered from.

18. The method of claim 16, wherein the combined reuse fluid is provided to a different food processing application from which the used fluid was recovered from.

19. The method of claim 1, further comprising measuring the turbidity of the recovered used fluid after the solid material from the recovered used fluid has been removed.

20. The method of claim 1, wherein the used fluid is recovered from a plurality of chiller tanks.

21. The method of claim 1, wherein the used fluid is recovered from a single chiller tank.

22. A system for reconditioning and re-use of a fluid used in a food processing application, the system comprising:
(a) a first receptacle for recovering the used food processing fluid after the fluid has been used in the food processing application;
(b) an apparatus for removing solid materials from the recovered used fluid:
(c) an outlet for removing about 1% to about 50% of the recovered volume of used fluid;
(d) an inlet for addition of an unused fluid and an effective amount of an antimicrobial agent, wherein the effective amount of the antimicrobial agent is based on a plurality of food processing parameters;
(e) piping for circulating the fluid through the system; and
(f) a plurality of pumps for circulating the fluid through the system.

23. The system of claim 21, wherein the apparatus for removing the solid materials from the collected used fluid is selected from the group consisting of a screen, a filter, dissolved air filtration, dissolved air flotation, a centrifuge, and combinations thereof.

24. The system of claim 21, wherein the used food processing fluid was used in a food processing application selected from the group consisting of washing, rinsing, preserving, sanitizing, disinfecting, sterilizing, harvesting, peeling, cutting, blanching, scalding, cooking, chilling, irrigating, flavoring, pickling, soaking, marinating, curing, coating, transporting, floating, separating, sorting, disposing, and combinations thereof.

25. The system of claim 21, wherein the used food processing fluid was used in a food processing application comprising a food packaging rinse application.

26. The system of claim 21, wherein the food processing parameters are selected from the group consisting of: a targeted level of microorganism inactivation; a targeted time for fluid reconditioning; the temperature of the used food processing fluid; decay of the antimicrobial agent in the combined reuse fluid; and combinations thereof.

27. The system of claim 26, wherein the targeted level of microorganism inactivation is a reduction between about a 0.50 and about a 12.0 Log₁₀ reduction in viable microorganism numbers per unit volume.

28. The system of claim 26, wherein the targeted level of microorganism inactivation is a reduction that results in the absence of microorganisms capable of growing in a food at a non-refrigerated temperature.

29. The system of claim 26, wherein the targeted time for fluid reconditioning is between about 0.5 minutes and about 15 minutes.

30. The system of claim 26, wherein the temperature of the used food processing fluid is between about −10° C. and about 100° C.

31. The system of claim 21, wherein the antimicrobial agent comprises a peroxygen compound.

32. The system of claim 31, wherein the peroxygen compound is selected from the group consisting of peroxyacetic acid, peroxyoctanoic acid, peroxyformic acid, peroxypropionic acid, peroxyheptanoic acid, peroxybenzoic acid, peroxynonanoic acid, monoperglutaric acid, diperglutaric acid, succinylperoxide, hydrogen peroxide, and mixtures thereof.

33. The system of claim 26, wherein the microorganism is selected from the group consisting of bacteria, fungi, parasites, protozoa, and combinations thereof.

34. The system of claim 33, wherein the microorganism is selected from the group consisting of Acinetobacter, Aeromonas, Alcaligenes, Bacillus, Campylobacter, Clostridium, Enterococcus, Flavobacterium, Lactococcus, Lactobacillus, Leuconostoc, Listeria, Micrococcus, Moraxella, Pediococcus, Pseudomonas, Shewanella, Staphylococcus, Vibrio, Streptococcus, Salmonella, Escherichia, Citrobacter, Enterobacter, Erwinia, Klebsiella, Proteus, Serratia, Shigella, Yersinia, Alternaria, Aspergillus, Aureobasidium, Botrytis, Byssochlamys, Cladosporium, Fusarium, Geotrichum, Mucor, Penicillium, Rhizopus, Candida, Cryptococcus, Rhodotorula, Saccharomyces, Trichosporon, Zygosaccharomyces, Picorvaviruses, Reoviruses, Parvoviruses, Papovaviruses, Adenoviruses, Rotaviruses, Hepatitis A virus, Norwalk virus, Giardia, Entamoeba, Cryptosporidium, Toxoplasma, flatworms, roundworms, and combinations thereof.

35. The system of claim 21, wherein the system further comprises a bypass line for bypassing the apparatus for removing the solid material from the collected used fluid during cleaning.
